(19) United States
(12) Patent Application Publication
(10) Pub. No.: US 2004/0172991 A1
(43) Pub. Date: Sep. 9, 2004

(54) Vending machine locking device

(76) Inventors: Patrick Forster, Westmont, IL (US); Kenneth G. Such, North Barrington, IL (US); Jack Chen, Oak Brook, IL (US)

Correspondence Address: Robert L. Marsh, P.O. Box 4468, Wheaton, IL, 60189-4468, US

(21) Appl. No.: 10/382,255

(22) Filed: Mar. 5, 2003

(51) Int. Cl. E05B 65/12; E05B 13/00

(52) U.S. Cl. 70/257; 70/208

(57) ABSTRACT

A door of a vending machine has an electrically operated lock that is operated by a hand held unit from outside the machine. In one embodiment of the lock a spike with grooves along the length thereof is engaged by an engagement unit having moveable blades. In a second embodiment a threaded screw is driven by a reversible motor to thread and unthread the screw into a threaded opening. The machine has detectors that detect the amount of product being dispensed by the machine and the amount of cash in the cash box and microprocessors and transceivers in both the machine and in the hand held unit convey this information to the hand held unit. The hand held unit may also program a slave hand held unit to have limited control over the functions of the machine.

The present invention relates to a method and apparatus for locking a dispensing device such as a vending machine, and specifically to an improved device that is electronically operated so as not to be visible from outside the vending machine thereby minimizing exposure to tampering.

### BACKGROUND OF THE INVENTION

Vending machines represent a major outlet for retail goods including packaged foods, desserts, candies, soft drinks, toys, and stamps and to wash and dry clothing. An operator of vending machines may have a hundred or more machines under his or her control, each of which must be routinely visited to resupply inventory, remove cash, and verify that the machine is in good operating conditions. Between such visits, however, the machine is accessible to the public, including thieves.

Existing vending machines consist of an enclosure, the forward surface of which consists of a door which is openable by a lock to replenish the magazines with goods and to remove cash. The locks of existing machines are openable using a conventional key. Although the enclosures and locks for such machines are constructed to discourage unauthorized entry, professional thieves will study the construction of such enclosures and locks and find the weakest portion of their construction, which is usually at the lock. A professional thief, having knowledge of the weaknesses of a vending machine and carrying proper tools, can defeat the lock of an existing vending machine and access its magazine and cash box within seconds.

Since the failure which allows unauthorized access to a machine typically occurs in the locking mechanism, it would be desirable to provide an improved locking mechanism usable for vending machines, and in particular to an improved locking mechanism for which the location of the locking structure is not visible from the exterior of the machine. It would also be desirable to provide a lock that will be sufficiently rugged to withstand abuses by the public.

### SUMMARY OF THE INVENTION

Briefly, the present invention is a method and apparatus for improving an owner's control over a vending machine by providing an improved locking device for locking and unlocking the machine, and to enable an operator to monitor the activity within the machine without opening the door. The device is usable on a vending machine having a box shaped body, with one surface of the body being open against which is a hinged door through which an operator can have access to the interior of the machine. A simplified embodiment of the invention is useable to lock, unlock, and monitor the activities within coin operated washers and dryers, however, for the purposes of this discussion the machine will be described and illustrated herein as a vending machine having a plurality of magazines for retaining goods to be dispensed, and a separately lockable cash box for retaining the proceeds of the sales of the goods.

In accordance with one embodiment of the lock, a rotatable screw is provided on either the door or the machine body and a threaded opening is provided on the other of the door and the machine body, the threaded opening positioned to receive the distal end of the rotatable screw as the door is closed. The rotatable screw is drivingly connected to a reversible motor for rotating the screw in a first direction, for threading the screw into the threaded opening and retaining the door against the body, and rotating the screw in a second direction for unthreading the screw from the opening and unlocking the door.

In the preferred embodiment, the threaded screw is axially moveable with respect to the motor from an extended position to a depressed position and a coil spring urges the screw toward the extended position. Movement of the screw to the retracted position actuates a switch connected to a control circuit, which may be a microprocessor. The control circuit also includes a clock for measuring a predetermined length of time, the predetermined length of time being sufficient for the motor to unscrew the screw from the threaded opening.

The device also includes a detector for measuring the electric power drawn by the motor as the screw is threaded into the threaded opening. The control circuit is responsive to the detector, and when the threads of the screw bind against the threads of the opening as the door is drawn to the fully closed position, the control circuit responds to the increased electric power being drawn by the motor to overcome the resistance of the binding threads by terminating the electric power directed to the motor.

The control circuit is configured to direct power to rotate the electric motor in the first direction (screwing in the screw) when the screw is axially depressed and the associated switch is actuated, and to terminate power for rotating the screw in the first direction when the control circuit detects that the motor is drawing an increased amount of electric power indicating that the threads are binding.

The device further includes a receiver within the body of the vending machine for receiving a code key transmitted from a position outside the vending machine. The control circuit is connected to the receiver and to the electric motor for directing electric power to the motor to rotate the screw in the second direction and unlock the vending machine upon the receipt of a code key by the receiver. Once power is applied, the control circuit continues to apply electric power to rotate the motor in the second direction until the predetermined period of time has elapsed on the clock. Power to the motor is then terminated and the door is unlocked.

A hand held transmitter is also provided to be carried by the operator of the vending machine, the transmitter adapted to transmit the code key readable by the control circuit within the box for unlocking the vending machine.

Once the door to the vending machine has been opened, the device includes a second electrically operable locking and unlocking device between the cash box and the cash box door. The second unlocking device is enclosed so as not to be accessible by one seeking unauthorized access to the cash therein and the control circuit which controls the application of electric power to the motor turning the screw also controls the application of electric power to the electrically operated unlocking device on the door to the cash box. In the preferred embodiment, the same receiver that receives the code key from the hand held transmitter to open the door to the body of the machine also receives a second code key in response to which the control circuit unlocks the electrically operated lock for the cash box.

After the cash has been removed from the cash box and the magazines of the machine refilled with goods for future sale, the door to the vending machine is closed until the distal end of the screw engages the threaded opening. When the screw engages the threaded opening, the screw is moved to the depressed condition and the motor is energized to rotate the screw in the first direction and thereby thread the screw into the threaded opening. When the threads of the screw bind with those of the threaded opening, the control circuit detects that the motor is drawing additional power, and power to the motor is terminated. The vending machine is then locked.

In another embodiment of the device, an elongate spike is provided on either the door or the machine body. The spike is cylindrical in shape and has at least one notch on the surface thereof. A moveable catch having opposing moveable plates spring loaded to move toward each other in a scissors configuration, is provided on the other of the door or the body for engagement with the spike as door is closed against the machine body. The spike is rotatable about its longitudinal axis from a first angular orientation in which the notch of the spike is engageable by the moveable catch for retaining the door in the locked orientation, and to a second angular orientation, preferably 90 degrees from the angular orientation, in which the notch is rotated away from the moveable catch to thereby allow removal of the spike from the catch and the opening of the door.

In this embodiment, the spike is rotated about its axis by any appropriate means, such as a solenoid. The device includes a receiver positioned within the box for receiving a code key from outside the machine, and a control circuit connected to the receiver and to the solenoid for rotating the spike from the locked position to the unlocked position upon receipt by the receiver of the appropriate code key. As in the first embodiment, a hand held transmitter, useable by the machine operator, is provided for transmitting the needed code signal from a position outside the vending machine for unlocking the machine and gaining access therein.

In another embodiment of the invention, two way communication is provided by providing infrared transceivers in both the machine and the hand held unit. In this embodiment, detectors are provided in the machine for detecting the amount of product discharged by each of the magazines within the machine, and a cash counter is provided on the coin receptor for calculating the amount of cash in the cash box. A microcomputer in the machine collects information from the detectors in the magazines and from the cash counter in the cash box and retains the information. Upon receipt of the code key signal, the transceiver in the vending machine will transmit a signal generated by the microprocessor for downloading to the hand held unit the information regarding product sales and cash accumulated from the detectors within the machine.

### BRIEF DESCRIPTION OF THE DRAWINGS

A better understanding of the present invention will be had after a reading of the following detailed description taken in conjunction with drawings wherein:

FIG. 1 is an isometric view of a vending machine embodying the present invention with the door thereof in a closed position;

FIG. 2 is an isometric view of the vending machine shown in FIG. 1 with the door thereof open showing an inner insulated door, the magazines for retaining product, and the discharge chute;

FIG. 3 is an isometric view of a first embodiment of a locking mechanism of the present invention;

FIG. 4 is an enlarged fragmentary cross-sectional view of the motor and screw assembly for the locking device shown in FIG. 3

FIG. 5 is a second isometric view of the motor and screw for the locking device shown in FIG. 3;

FIG. 6 is a rear-elevational view of a locking device in accordance with a second embodiment of the invention;

FIG. 7 is a cross-sectional view of the device shown in FIG. 6 taken through line 7-7 thereof;

FIG. 8 is a side-elevation view of the spike shown in the device of FIG. 6;

FIG. 9 is a second side-elevation of the view of the spike shown in FIG. 8 where the spike has been rotated 90 degrees about its axis;

FIG. 10 is a front elevational schematic view of a scissors catch with the spike of the device shown in FIG. 6 extending between the blades thereof;

FIG. 11 is a side-elevational view of the catch shown in FIG. 10;

FIG. 12 is a cross-sectional view of the catch shown in FIG. 10 taken through line 12-12 of FIG. 10 and line 12-12 of FIG. 11;

FIG. 13 is a second cross-sectional view of the catch shown in FIG. 10 taken through line 13-13 of FIG. 11;

FIG. 14 is a schematic diagram of the elements for operating the locking device shown in FIG. 3;

FIG. 15 is a schematic diagram of the elements of the device shown in FIG. 6;

FIG. 16 is a schematic diagram of the elements of a third embodiment of the present invention; and

FIG. 17 is a schematic diagram of additional aspects of the embodiment depicted in FIG. 16.

### DETAILED DESCRIPTION OF THE PREFERRED EMBODIMENT

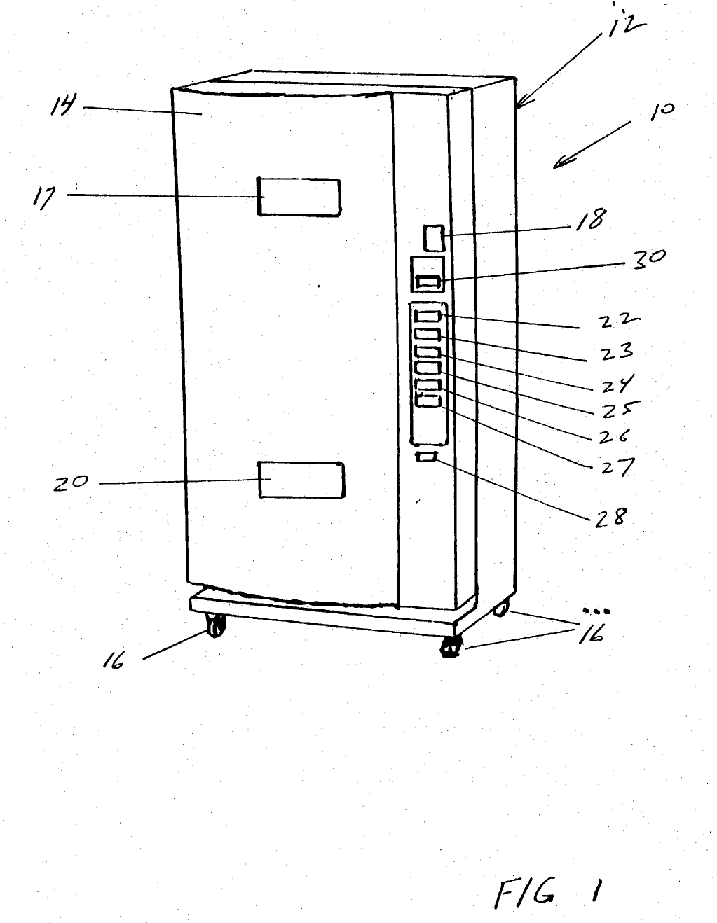

Referring to FIG. 1, a vending machine 10 includes a generally box-shaped machine body 12 having an open front, and closeable against the open front of the machine body 12 is an outer door 14. The machine 10 is moveable on a plurality of casters 16 and the outer surface of the door 10 includes advertising material 17 for advertising the products to be dispensed by the machine 10. The outer surface of the door 10 also includes a coin receptor 18, or any other device for receiving payment for goods to be dispensed by the machine, and an access opening 20 through which a purchaser can access the goods dispensed by the machine. Also positioned on the front of the machine are a plurality of selector buttons 22-27, any one of which may be depressed by a patron who has deposited the necessary funds to purchase the selected goods after which the goods will be dispensed to the access opening 20. Below the selector buttons is a refund slot 28 into which excess funds deposited by a purchaser can be returned, or for refunding all the funds deposited in the event the selected magazine is empty.

Existing vending machines also have on the forward surface of the door 14 thereof, a panel for a key slot 30 for receiving a conventional key for thereby unlocking the door 14 from the machine body 12. In a machine modified to receive the locking device of the present invention, the key slot 30 is replaced by a metal panel to secure the outer surface of the machine from unauthorized access to the locking device within.

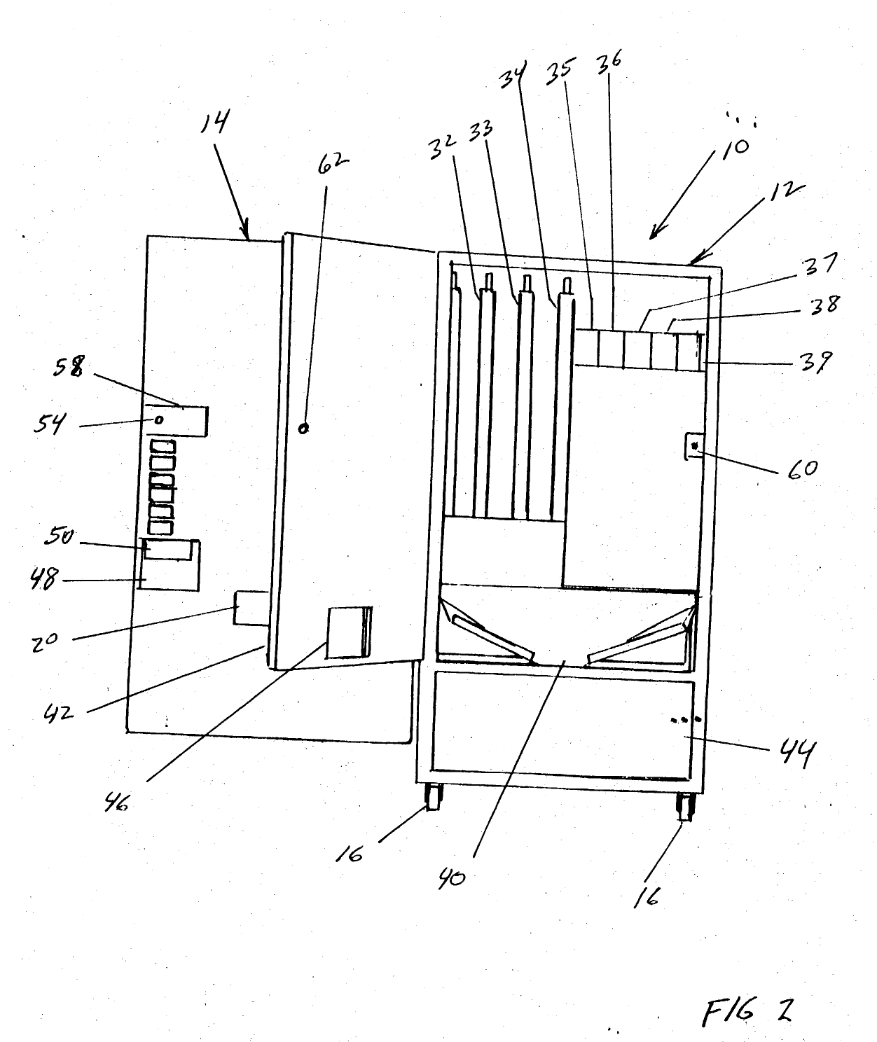

Referring to FIG. 2, within the vending machine 10 are a plurality of vertical magazines 32-39 for receiving goods to be dispensed by the machine. Below the magazines 32-39 is a discharge chute 40. Where the machine 10 is intended to dispense refrigerated items such as soft drinks and the like, the vending machine 10 includes an insulated inner door 42, and enclosed in the lower portion 44 of the machine body 12 is a refrigeration unit, not shown, for maintaining the interior of the machine body 12 at the desired temperature.

The inner door 42 has a aperture 46 therein, which is aligned with the access opening 20 of the door 14 and the discharge chute 40 in the machine body 12 such that when the inner door 42 and the outer door 14 are closed, a patron can reach his hand through the access opening 20 and through the aperture 46 to retrieve a product at the bottom of the discharge chute 40.

The inner surface of the door also includes a cash box 48 with a separately openable cash box door 50. Prior art cash box doors included a key slot for receiving a key and opening the cash box 48. In accordance with the present invention, however, all the operating elements of the lock for retaining the door 50 of the cash box 48 in the closed orientation are securely enclosed so as not to be visible or accessible by merely opening the door 14 of the machine 10.

Referring to FIGS. 2 through 5, the vending machine 10 also includes a locking device 52 in accordance with the present invention. The locking device 52 includes a rotatable screw 54 driven by a reversible motor 56 driving through a gear train 57. The motor 56, the gear train 57 and the rearward end 68 of the screw 54 all within an enclosure 58 mounted on the inner surface of the door 14. A complementary threaded opening 60 extending through a plate 61 mounted to the inner wall of the machine body 12, is positioned to receive the distal end of the screw 54 when the door 14 is closed against the body 12. A hole 62 in the insulated inner door 42 permits the distal end of the screw 54 to pass therethrough so as to engage the threaded opening 60 without interference from the inner door 42.

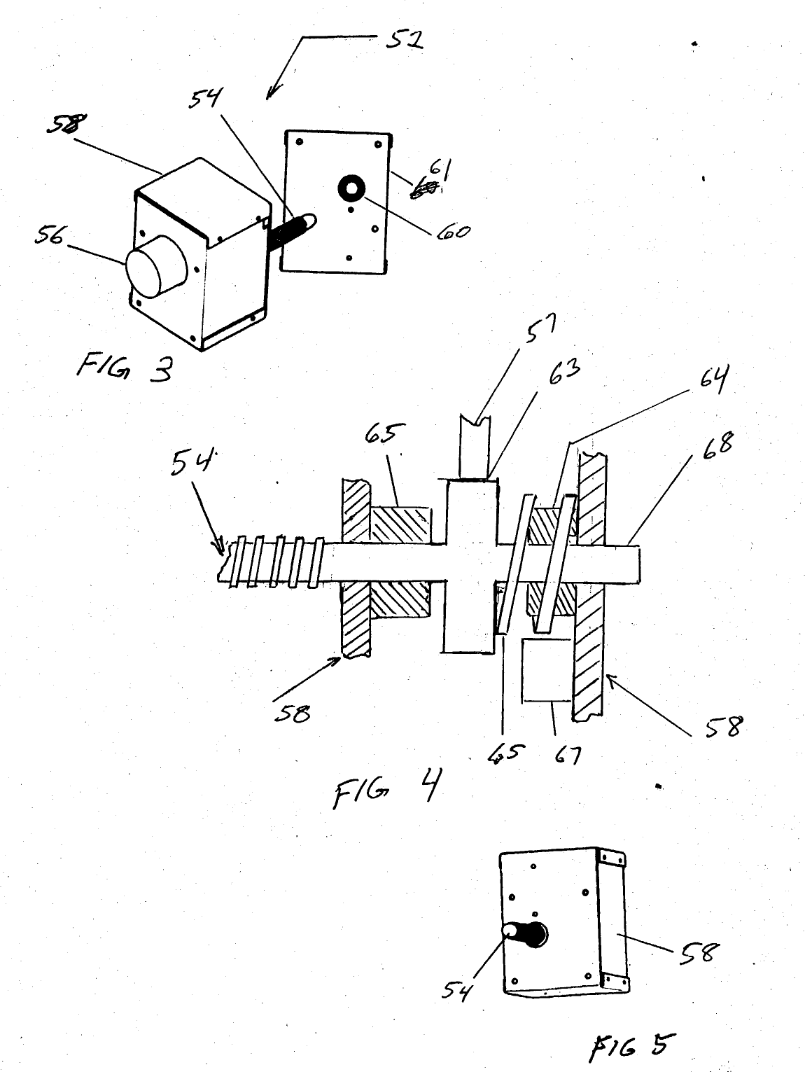

Referring to FIG. 4, midway along the length of the rearward end 68 of the screw 54 is a radial flange 63, the outer circumference of which has the teeth, not shown, of a gear for engagement with the gear train 57. The shaft 68 is rotatable within bushings 64, 65 positioned at opposite ends of the enclosure 58, and the shaft 68 is axially moveable within the bushings 64, 65. A coil spring 66 is positioned between the rearward bushing 64 and the rearward surface of the radial flange 63 for urging the screw 54 outward of the enclosure 58 and outward movement of the screw 54 is limited by engagement of the outer surface of the radial flange 63 against the inner surface of bushing 65. A switch 67 positioned on the rearward panel 63 of the enclosure 58 is actuated by rearward movement of the radial flange 63 compressing the spring 65.

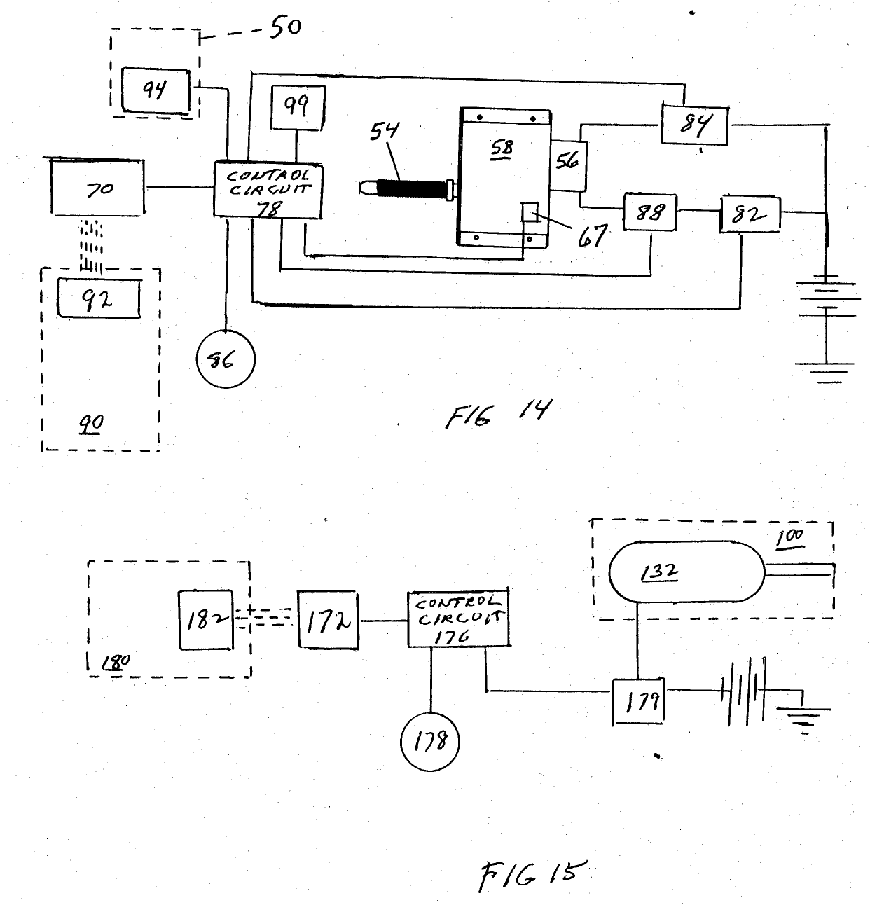

Referring to FIG. 14, the device also includes an infrared receiver 70, which may be positioned anywhere on the door 14, where its location will be concealed behind a semi-transparent plastic that covers portions of the door, the plastic being of the type commonly known in the art. The infrared receiver 70 receives incoming infrared transmissions and conveys the information therein to a control circuit 78, which may be a microprocessor, for controlling the functions of the device 52. Specifically, the control circuit controls switch 82 which, when closed, directs power to the motor 56 for rotating it in the first direction for locking the door 14, and controls switch 84 which, when closed, directs power to the motor 56 for rotating it in the second direction for unlocking the door 14.

The rotation of the screw 54 in a first direction, in which the threads of the screw 54 engage the threads of the threaded opening 60, will draw the door 14 against the machine body 12 after which the threadings of the screw 54 and the openings 60 will bind against each other and cause resistance to further rotation of the screw 54. An ammeter 88 in the circuit for directing power to the motor 56 for rotating the motor in the first direction detects when the motor 56 draws additional power to overcome the resistance as the threads of the screw 54 bind against the threads of the opening 60.

The control circuit 78 includes a clock 86 for measuring a predetermined length of time, such as five seconds. The control circuit is configured to close switch 82 to direct power to the motor 56 for rotation of the motor 56 in the first direction to thereby thread the screw 54 in to the opening 60 when the switch 67 is actuated, indicating that the distal end of the screw 54 is contacting the threaded opening 60. The control switch 78 will continue directing power to rotate the motor 56 in the first direction until the control circuit 78 determines from a reading of the ammeter 88 that the power being drawn by the motor 56 has risen to a level indicative of binding between the threads of the screw 54 and the opening 60, after which the control unit 78 will open switch 82 terminating power to the motor 56 and the door 14 will then be locked.

A hand held unit 90 is provided that is usable by an operator includes a transmitter 92 for sending an infrared beam containing the predetermined unlock code to the receiver 70 that is readable by the control circuit 78. The control circuit 78 is also configured to open switch 84 and direct power to the motor 56 in the second direction when the control circuit 78 recognizes that the correct code key has been received by the receiver 70, thereby unscrewing the screw 54 from the opening 60. The control circuit 78 will continue to direct power to drive the motor 56 in the second direction until the predetermined period of time as determined by the clock 86 has elapsed, after which the control circuit will open switch 84 and the vending machine 10 will be unlocked.

In the preferred embodiment, the hand held unit 90 can transmit a second code receivable by the receiver 70, which when recognized, the control circuit 78 will close a third switch 94 to operate a second electrically operable unlocking device 98 for unlocking the cash box door 50.

As an alternative to sending a second code key, the device 52 can be configured such that the control circuit 78 will recognize the first use of the code key as coming from a hand held unit 90, the user of which is authorized to enter the cash box 48. In this embodiment the machine 10 is fitted with a detector 99 for determining when the door 14 is open and the control circuit 78 is configured to close switch 94 to unlock the cash box door 50 upon a second transmission of the code key from the hand held unit 90 to the receiver 70 while the detector 99 indicates that the door 14 is open.

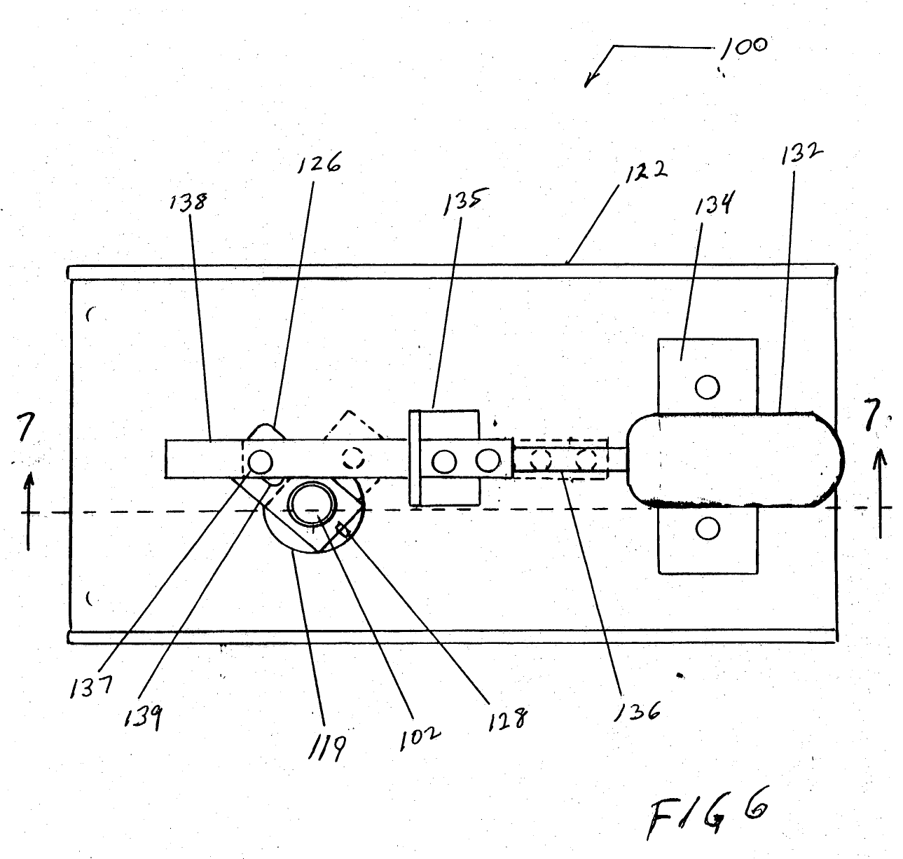

Referring to FIGS. 6 through 13, a second embodiment of a door-latching device 100 includes a generally cylindrical elongate spike 102 having a conical tip 104 and axially aligned along the outer surface of the spike 102 is a first plurality of longitudinally spaced transverse grooves 104-107, and diametrically opposite the first plurality of transverse grooves 104-107 is a second plurality of longitudinally spaced transverse grooves 108-111. As best shown in FIGS. 8 and 9, each of the grooves 104-111 includes a planar surface 112 perpendicular to the axis 114 of the spike 102 and a ramp surface 116 oriented at an angle of approximately 30 degrees to the axis 114 with the surfaces 116 and 114 intersecting in a line 117. Rearward of the transverse grooves 104-111 is a radial groove 118 for receiving a retaining washer 120 or the like for rotatably retaining the spike 102 against being withdrawn from a mounting plate 122. Rearwardly spaced from the groove 118 is a radial flange 119, and between the flange 119 and the rearward surface of the plate 122 is a bushing 124 for rotatable retaining the spike 102 to the plate 122 while preventing axial movement of the spike 122. A cam 126 is fitted over the rearward end of the spike 102 and the cam 126 is locked for rotation therewith by a pin 128 extending through the cam 126 and into a transverse locking hole 130 in the spike 102.

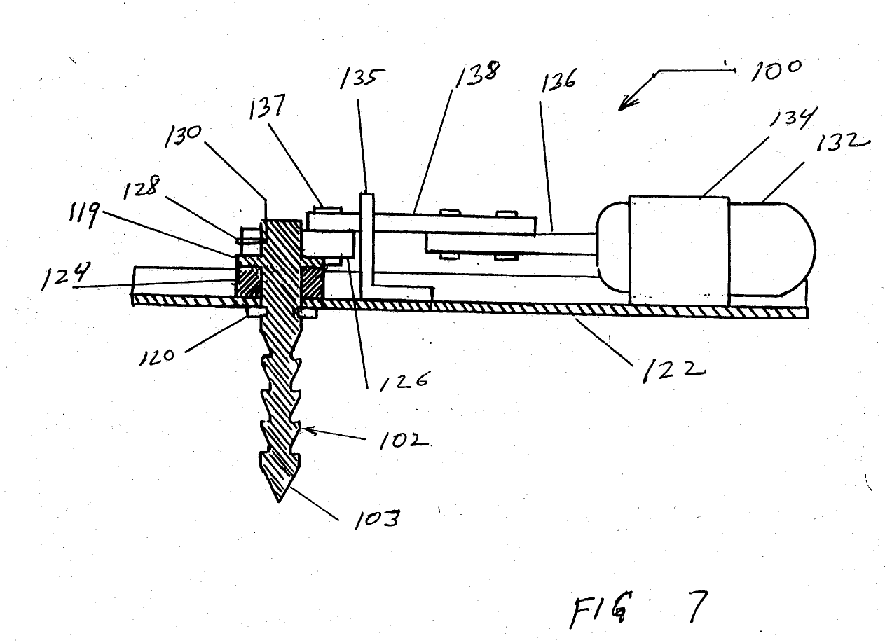

Referring to FIGS. 6 and 7, a solenoid 132 is secured by a strap 134 to the rearward surface of the mounting plate 122 and the distal end of an axially moveable arm 136 extending from the solenoid 132 is connected to an elongate arm 138. The connecting arm 138 is slideably moveable through an opening, not shown, in a guide 135 attached to the mounting plate 122, and the distal end of the connecting arm 138 is pivotally connected by a pivot pin 137 to the end of the cam 126. The cam 126 has a radial slot 139 therein to permit the pin 137 to move with respect to the cam as the cam 126 rotates. Activation of the solenoid 132 will draw the arm 136 from the extended position, shown in solid lines in FIG. 6, to the retracted position, shown in broken lines in FIG. 6, and thereby will rotate the spike 102 approximately 90 degrees about its longitudinal axis.

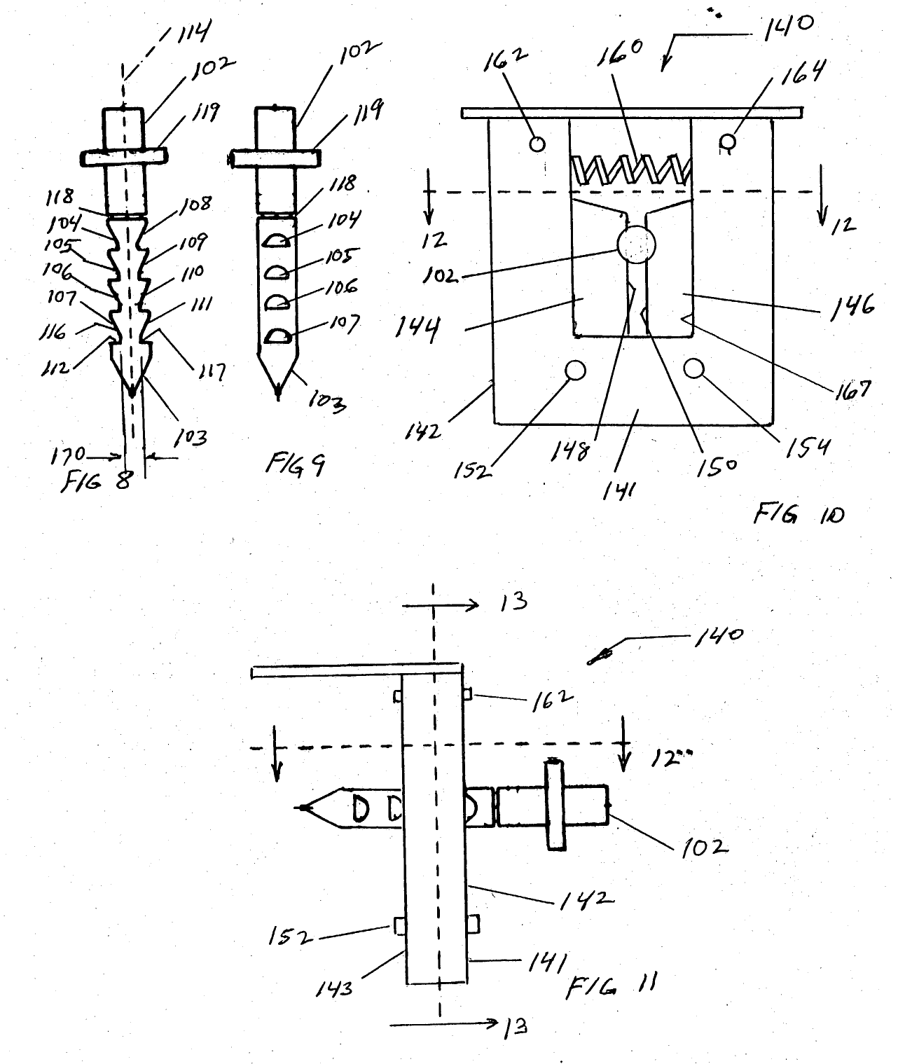

Referring to FIGS. 10 through 13, when the door 14 having a closing device 100 thereon is closed against a machine body 12, the spike 102 will extend into an engagement unit 140 having a rectangular shaped housing 142 having a forward panel 141 and a rearward panel 143. Within the housing 142 are a pair of generally rectangular blades 144, 146 made of a suitably strong sheet metal steel or the like with the blades 144, 146 having generally linear blade edges 148, 150 oriented parallel to each other and spaced a short distance from one another. The blades 144, 146 are pivotally mounted at a first end thereof on pivot pins 152, 154 respectively. Each of the blades 144, 146 has a hole 156, 158 at the opposite ends thereof into which is inserted one end of a coil spring 160, the coil spring 160 adapted to draw the moveable ends of the blades toward each other. A pair of spaced role pins 162, 164 extending through the forward and rearward panels 141, 143 of the housing 142 are positioned to be contacted by the edges 148, 150 of the blades 144, 146. The role pins 162, 164 prevent the blades 144, 146 from being drawn by the spring 160 into contact with each other and maintain the blade edges a distance 168 apart from one another. The forward and rearward panels 141, 143 have the cut out central portions to permit the spike 102 to extend through the blades 144, 146 without interference from the panels 141, 143, the cut out portion167 of panel 141 being visible in FIG. 10.

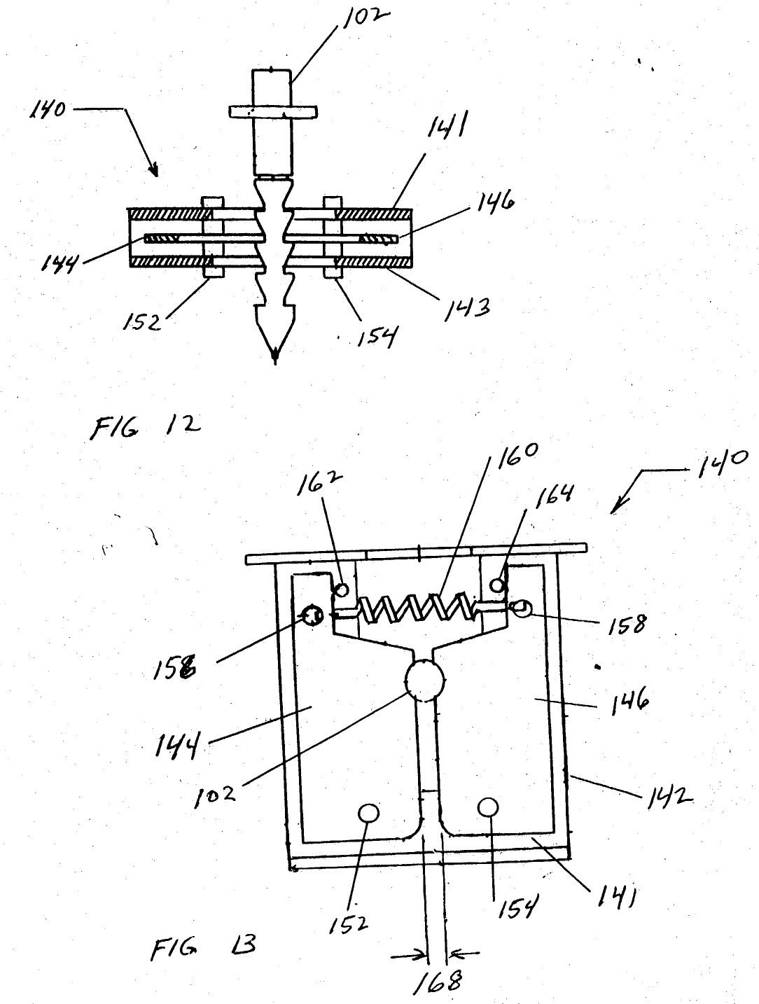

Referring to FIGS. 8 through 13, the spacing 168 between the blade edges 148 is approximately equal to the distance 170 between inner edges 117 of opposing grooves 104-111 of the spike 102. Accordingly, when the door 14 of the vending machine 10 has a device 100 mounted thereon, the spike 102 thereof is positioned so the conical tip 102 will pass between the edges 148, 150 of the blades 144, 146 as the door 14 is closed against the body 12. As the spike 102 moves between the blades 144, 146 the conical tip 104 will urge the blades apart thereby allowing the shaft of the spike 102 to move between the blades. Further movement of the spike 102 between the blades will move the first pair of opposing grooves 104, 108 between the blades and the spring 160 will urge the blades 144, 146 toward each other and behind the planar surfaces 112 of the first set of grooves 104, 108, thereby preventing withdrawal of the spike 102 from the blades. As the spike 102 is further inserted between the blades 144, 146, successive pairs of grooves pass between the blades until the door 14 is fully closed against the machine body 12. As best shown in FIG. 12, the door will thereafter be retained in closed position by the engagement of the planar surfaces 112 of each of the opposing pairs of grooves against the edges 148, 150 of the blades 144, 146.

Referring to FIG. 15, the device 100 further includes an infrared receiver 172 positioned on the outer surface of the door 14 and concealed behind a partially transparent outer surface so that its location is not visible from outside the machine 10. A control circuit 176 is connected to the infrared receiver 172. The control circuit 176 includes a clock 178 for measuring a predetermined period of time and is connected to a switch 179 in the power circuit for the solenoid 132. The control circuit 176 is configured to look for a predetermined code key to be received by the receiver 172, and upon receipt of the code key, to close switch 179 and energize the solenoid 132 causing the spike 102 to rotate 90 degrees. If the door 14 is then in the closed position and the spike 102 is positioned between the blades 146, 147, as shown in FIG. 11, the rotation of the spike 90 degrees will cause the grooves 104-111 to be rotated from between the blades 144, 146 thereby urging the blades apart from one another and allowing the spike 102 to be withdrawn without further engaging the blades 144, 146.

The control circuit 176 will maintain power to the solenoid 132 until the predetermined interval of time as determined by the clock 178 has elapsed, thereby allowing sufficient time to open the door 14. After the predetermined period of time has elapsed, the control circuit 176 will open the switch 179 and thereby terminate power to the solenoid 132. Upon termination of power to the solenoid 132, the shaft 134 will again be drawn outward thereof and the spike 102 will rotate from the position shown in FIG. 9 back to the position shown in FIG. 8. The spike is again in position for engaging the blades 144, 146 of the engagement unit 140 when the door is subsequently closed.

The device 100 further includes a hand held unit 180 with a transmitter 182 similar to the hand held unit 90 of the first embodiment for use by the operator. The transmitter 182 generates a code key to be received by the receiver 172 when the vending machine 10 is to be opened. Like the first embodiment 52, the device 100 may be adapted to receive a second code signal for unlocking the door 50 of the cash box 48.

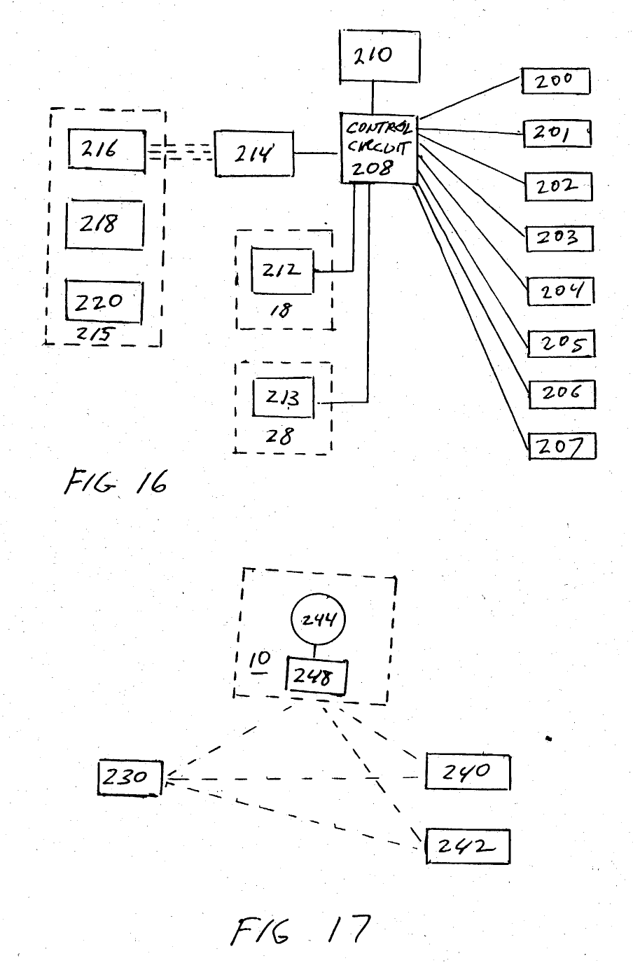

Referring to FIG. 16, a vending machine 10 having a door locking device 52, 100, as previously described, may be further embellished in accordance with the third embodiment of the present invention. In this embodiment, detectors 200-207 are positioned in the magazines of the machine 10 to detect when a item of product is discharged from each of the respective magazines 32-39 and the signals from the detectors 200-207 are directed to a control circuit 208, which may be a microcomputer having a memory 210 such that the memory 210 will retain therein the number of each of the products sold by the machine over a given period of time. The coin receptor 18 and coin return 28 are also fitted with the detectors 212, 213 also connected to the control circuit 208 for storing in the memory 210 the total cash received by the receptor 18, less refunds form the coin return 28, and therefore the total amount of cash in the cash box 48. The body of the machine is fitted with an infrared transceiver 214, which replaces the infrared receiver 82, 172 previously described. The hand held unit 215, is fitted with a second transceiver 216 and a microprocessor 218 with a memory 220 for interacting with the transceiver 214 in the machine 10. Upon receipt of a code key from the hand held unit 215, the control circuit 208 in the machine 10 will transmit a code message through the transceivers 214, 216 conveying the information stored in the memory 210 in the machine 10 to the memory 220 of the hand held unit 215. The hand held unit 215 will thereafter have stored in its own memory 220, an updated record of the product sales and cash received by the machine 10.

Referring to FIG. 17, there are many modifications and variations of the invention which can be carried out. For example, the device may include a master hand held unit 230, which would allow the owner of the machine 10 to fully control all the functions of the vending machine 10, including the setting and resetting of the code key to which the machine 10 will respond. The master unit 230 can thereby control slave units 240, 242 to thereby permit subordinates to have limited access to the machine 10. Where a clock 244 is provided in the machine, the master unit 232 may be used to signal the microprocessor 248 in the machine to only allow access by the slave units 240, 242 within certain intervals of time, or on certain days of the week. In similar fashion, the master unit 230 may be used to deactivate lost slave units, activate new slave units, and allow the holders of slave units only partial entry to the machine, for example to the magazines but not to the cash box. The slave units 240, 242 may be programmed by the master unit 230 to deliver instructions to the microprocessor 248 in the machine 10 on behalf of the master unit 230. The control circuit 248 will also control all the locking and unlocking functions with respect to the embodiment of the devices 52 and 100 described above.

While the invention has been described with respect to a vending machine for dispensing products it should be appreciated that the invention is usable on coin operated copy machines, washers, dryers, and any other type of coin operated machine left unsupervised where it is usable by the public.

While the present invention has been described with respect to several embodiments, it will be appreciated that there are many modifications and variations that fall within the true spirit and scope of the invention. It is therefore the intent of the dependent claims to cover all such modifications and variations that fall within the true spirit and scope of the invention.

What is claimed:

1. A lock for locking a door closed against the body of an enclosure said lock comprising
a spike on one of said door and said body, said spike having an axis,
said spike having a cylindrical surface and at least one notch in said cylindrical surface,
a catch on the other of said door and said body, said catch having a moveable blade having an engagement orientation,
means for urging said catch into said engagement orientation, and
said spike rotatable about said axis from a first angular orientation wherein said notch on said spike is engageable by said catch to a second orientation wherein said notch on said spike is not engageable by said catch.

2. The lock of claim 1 and further comprising a solenoid having a moveable arm
said arm connected to said spike for rotating said spike from said first orientation to said second orientation.

3. The lock of claim 1 and further comprising
power means connected to said spike for rotating said spike from said first orientation to said second orientation in response to an unlock signal,
a receiver in said machine for receiving a code key,
means between said receiver and said power means for generating said unlock signal, and
hand held means for transmitting said code key to said receiver from a location outside said enclosure.

4. The lock of claim 3 wherein said spike, said moveable catch, said means for urging said catch, said power means, said receiver, and said means between said receiver and said power means are all enclosed within said enclosure when said door is closed against said body of said enclosure.

5. The lock of claim 4 wherein said enclosure is a vending machine.

6. A lock for locking and unlocking a closeable door against the body of an enclosure, said lock comprising
a rotatable screw having threads thereon on one of said door and body,
an opening on the other of said door and said machine body for threadedly receiving said screw, said opening having threads therein complementary to said threads of said screw,
a reversible motor drivingly connected to said screw for rotating said screw in a first direction for threading said screw into said threaded opening and rotating said screw in a second direction for unthreading said screw from said threaded opening,
detection means for generating a signal when said threads of said screw are binding against said threads of said opening, and said screw is rotating in said first direction, and
means for terminating power to said motor while said motor is rotating in said first direction upon receipt of said signal from said detection means.

7. The lock in accordance with claim 5 and further comprising
a clock for measuring a predetermined length of time, and
control means for controlling the application of electric power to said motor, said control means connected to said detection means and said clock for terminating power for rotating said motor in said first direction upon receipt of a signal from said detection means and for terminating power for rotating said motor in said second direction upon receipt of a signal from said clock indicative of the passage of said predetermined length of time.

8. The lock of claim 7 and further comprising
a receiver in said enclosure,
said receiver generating a signal in response to the receipt of a transmission of a code key,
means between said receiver and said motor for directing power to said motor upon receipt of said signal from said receiver, and
hand held means for transmitting said code key to said receiver from a location outside said enclosure.

9. The lock in accordance with claim 5 and further comprising
second detection means for detecting when said screw is unthreaded from said threaded opening,
control means for controlling the application of electric power to said motor, said control means connected to said detection means and said second detection means for terminating power for rotating said motor in said first direction upon receipt of said signal from said detection means and for terminating power for rotating said motor in said second direction upon receipt of said second signal from said second detecting means.

10. The lock in accordance with claim 9 and further comprising
a receiver in said enclosure,
said receiver for receiver for receiving a code key,
means between said receiver and said motor for directing power to said motor upon receipt of said code key by said receiver, and
hand held means for transmitting said code key to said receiver from a location outside said enclosure.

11. The method of unlocking a vending machine of the type having a door hinged to a machine body, said method comprising the steps of
providing a hand held transmitter for transmitting a code key from a location outside said vending machine.
providing an electrically unlockable lock between said door and said machine body for unlocking said door in response to an electric unlock signal,
providing a receiver in said vending machine for receiving a transmission of said code key,
providing means connected to said receiver and said electrically unlockable lock for generating an unlock signal for unlocking said electrically operable lock upon said receiver receiving said code key, and
providing a hand held transmitter for transmitting said code key to said receiver from a location outside said vending machine.

12. The method of claim 11 wherein said vending machine has an inner cash box having a cash box door and said method comprises the further steps of
said hand held transmitter having means for transmitting a second code key,
providing a second electrically unlockable lock between said cash box and said cash box door for locking said cash box door,
providing second means in said vending machine for detecting said second code key, and
providing means connected to said second means and said second electrically unlockable lock for unlocking said second electrically unlockable lock upon receipt of said second code key.

13. The method of claim 11 and comprising the further steps of
an operator using said hand held transmitter to transmit said code key to said receiver,
said receiver receiving said transmission, and
said electrically unlockable lock unlocking said door from said machine body.

14. The method of controlling a vending machine having a machine body and a door closeable against said body, said method comprising the steps of
providing a hand held unit for transmitting a coded signal,
providing an electrically unlockable lock for retaining said door locked against said machine body, and
providing means within said vending machine for receiving said coded signal and for unlocking said electrically unlockable lock upon receipt of said coded signal.

15. The method of claim 14 wherein said vending machine has a cash box and a cash box door and said method includes the further steps of
providing means in said hand held transmitter for transmitting a second code key,
providing a second electrically unlockable lock between said cash box and said cash box door for locking said cash box door,
providing second means in said vending machine for detecting said second code key, and
providing means connected to said second means and said second electrically unlockable lock for unlocking said second electrically unlockable lock upon receipt of said second code key.

16. The method of claim 14 wherein said vending machine contains a plurality of magazines and said method comprises the further steps of
providing a detector for providing a signal responsive to the number of products dispensed from one of said plurality of magazines,
providing a transmitter in said vending machine for transmitting a coded message containing said number of products dispensed from said one of said magazines, and
providing a receiver in said hand held unit for receiving said coded message from said vending machine.

17. The method of claim 14 and comprising the further steps of
providing a hand held slave unit, and
providing programming means between said hand held unit and said hand held slave unit for limiting control of said vending machine by said hand held slave unit.
